(19) United States
(12) Patent Application Publication
(10) Pub. No.: US 2017/0343418 A1
(43) Pub. Date: Nov. 30, 2017

(54) THERMAL CAMERA CALIBRATION PALETTE

(71) Applicants: Erin Hurbi, San Francisco, CA (US); Michael Nikkhoo, Saratoga, CA (US); Igor Markovsky, San Jose, CA (US); Shahar Ben-Menahem, Menlo Park, CA (US)

(72) Inventors: Erin Hurbi, San Francisco, CA (US); Michael Nikkhoo, Saratoga, CA (US); Igor Markovsky, San Jose, CA (US); Shahar Ben-Menahem, Menlo Park, CA (US)

(21) Appl. No.: 15/167,888

(22) Filed: May 27, 2016

(51) Int. Cl. G01J 5/10; H04N 5/33; H04N 17/00; G01J 5/00

(52) U.S. Cl. CPC G01J 5/10; H04N 17/002; H04N 5/33; G01J 2005/0077; G01J 2005/0048

(57) ABSTRACT

An apparatus including a palette body, a plurality of heat distribution plates mounted on the body and positioned adjacent each other, a plurality of insulators positioned intermediate the adjacently positioned heat distribution plates, and a plurality of thermal camera calibration reference swatches including a near-ideal blackbody reference swatch, a diffuse reflective reference swatch, and a first material of the device under testing reference swatch, each reference swatch being mounted on a corresponding one of the heat distribution plates and thermally insulated from other reference swatches by the insulators.

### BACKGROUND

Thermal cameras provide a non-contact, non-destructive measurement of wide-range temperature variations. However, measurements of absolute temperatures from thermal cameras have a relatively high degree of uncertainty, caused by both atmospheric conditions between the thermal camera and the object being measured, and the object's surface spectral/angular emissivity signature. Previous solutions include separately measuring a blackbody reference by itself or in conjunction with auxiliary reflecting surfaces standardized with respect to texture and material. Such procedures are used to calibrate the thermal camera for the atmospheric conditions and object emissivity, before measuring the object. However, these solutions require time consuming calibration steps, and only provide calibration for local atmospheric conditions.

### SUMMARY

To address the issues discussed above, an apparatus for use in measuring a temperature of a device under testing is provided. The apparatus comprising a palette body, a plurality of heat distribution plates mounted on the body and positioned adjacent each other, a plurality of insulators positioned intermediate the adjacently positioned heat distribution plates, and a plurality of thermal camera calibration reference swatches including a near-ideal blackbody reference swatch, a diffuse reflective reference swatch, and a first material of the device under testing reference swatch, each reference swatch being mounted on a corresponding one of the heat distribution plates and thermally insulated from other reference swatches by the insulators.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example temperature measurement system for use in measuring a temperature of a device under testing according to an embodiment of the present description.

FIG. 2 shows an example temperature measurement error corrected by the temperature measurement system of FIG. 1.

FIG. 3 shows another example temperature measurement error corrected by the temperature measurement system of FIG. 1.

FIG. 4 shows an overhead view of an example palette body of the temperature measurement system of FIG. 1.

FIG. 5 shows a side view of the example palette body of FIG. 4.

FIG. 6 shows an example method for measuring a temperature of a device under testing using the temperature measurement system of FIG. 1.

FIG. 7 shows an example computing system according to an embodiment of the present description.

### DETAILED DESCRIPTION

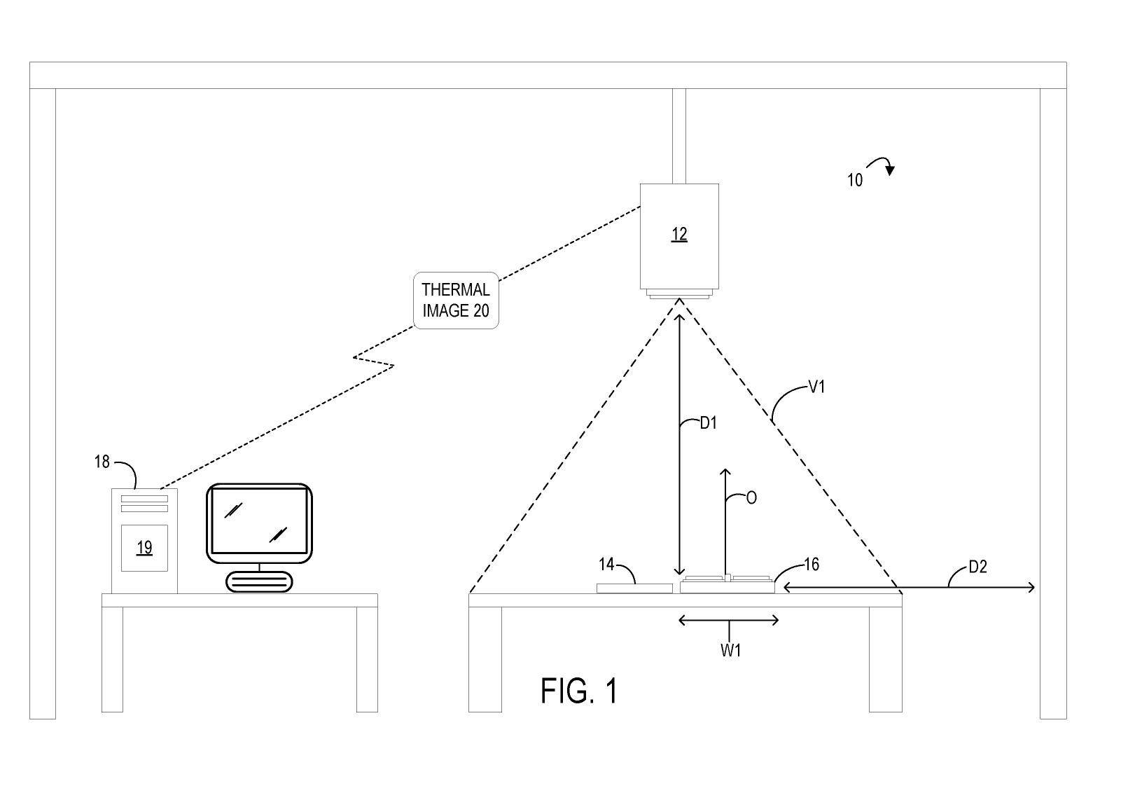

FIG. 1 illustrates a temperature measurement system 10 according to one embodiment of the present disclosure. As shown, the temperature measurement system 10 includes a thermal camera 12, a device under testing 14, a palette body 16, and a computing device 18. The thermal camera 12 may, for example, take the form of infrared sensors configured for non-contact, non-destructive measurement of temperature variations over an entire field of view VI of the thermal camera 12. The device under testing 14 may take the form of an electronic device, such as a motherboard, processor, or graphics processing unit as a few non-limiting examples. However, it will be appreciated that the device under testing 14 may take the form of any material that has a temperature measurable by the thermal camera 12. The computing device 18 may, for example, take the form of a desktop computing system as illustrated in FIG. 1. However, it will be appreciated that the computing device 18 may take other suitable forms, such as a laptop, a mobile computing device, a remote computing device configured to receive image data from the thermal camera 12 over a communication network, etc.

The computing device 18 includes a processor 19 configured to receive a thermal image 20 of the device under testing 14 and the palette body 16 from the thermal camera 12. The thermal image 20 include thermal data for each focal plane array “pixel” of the thermal camera, or for each image element acquired by a particular infrared imaging scanning sensor location of the thermal camera during its scanning excursion. After receiving the thermal image 20, the processor is configured to measure a temperature of the device under testing and the palette body 16 based on the thermal image.

Typically, absolute temperature signals measured using a thermal camera have a degree of uncertainty caused by several different factors, such as, for example, atmospheric and surface conditions including composition and texture of ambient air and of local infrared light emitting surfaces; surrounding environmental objects and materials and their temperatures; and the spectral/directional emissivities and reflectances of those environmental features as well as of the device under testing 14. These factors may cause thermal imaging using a thermal camera to exhibit both variations and fixed uncertainties in temperature readings larger than one degree Celsius, for the same device under testing (DUT) temperature and under different atmospheric and/or other environmental conditions; or across different DUT materials, even under identical temperature, atmospheric, and other environmental conditions.

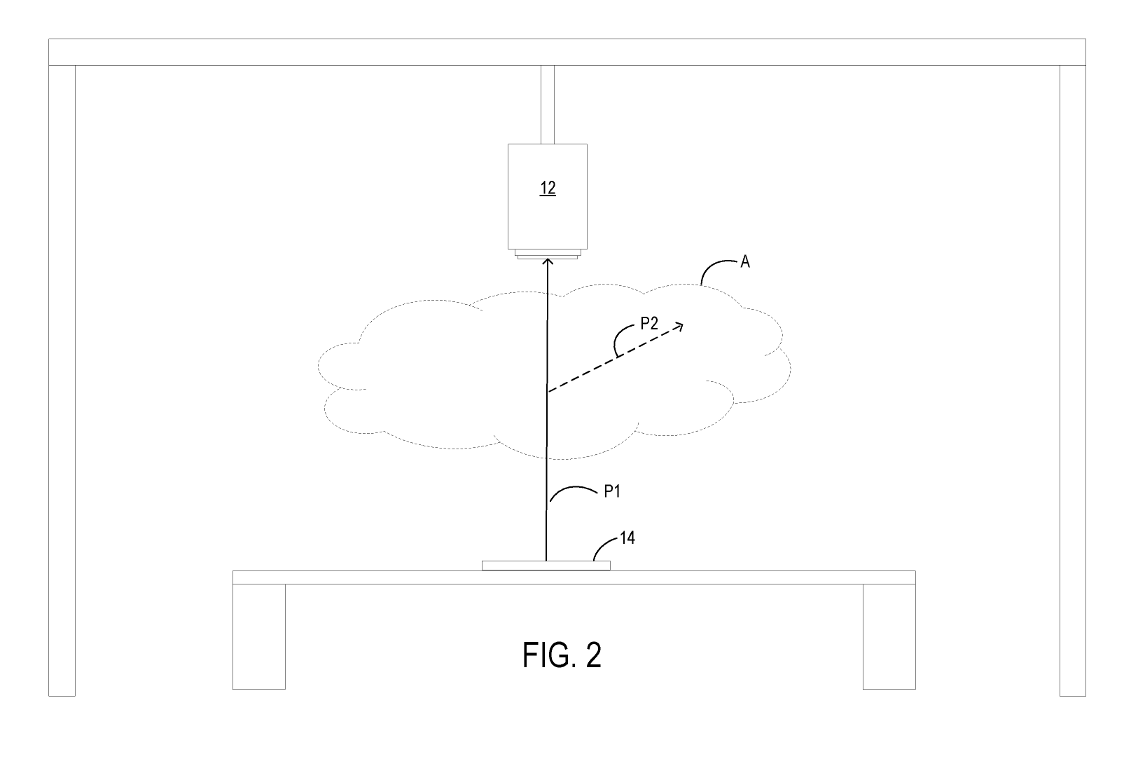

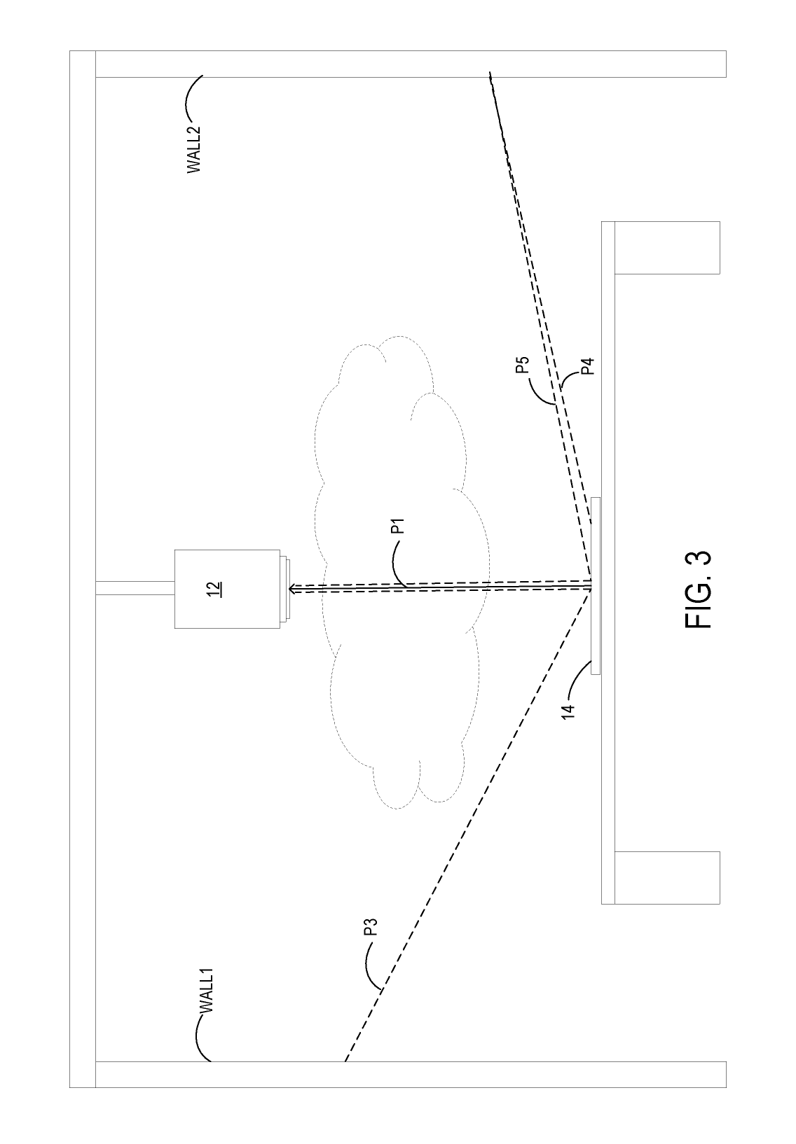

Examples of the factors discussed above are illustrated in FIGS. 2 and 3. FIG. 2 illustrates one example of how atmospheric conditions may affect the temperature of the device under testing 14 as measured by the thermal camera 12. As shown, the device under testing 14 emits electromagnetic radiation that is detected by the thermal camera 12. In the illustrated example, the thermal camera measures the temperature of the device under testing by electronically counting photons arriving at each pixel well of the camera, such as a particular infrared sensor, during an integration time period, such as one millisecond, although it will be appreciated that any suitable integration time period may be utilized. As shown, the photons P1 traveling from a particular surface element of the device under testing 14 are measured by a pixel well of the thermal camera. However, before the photons P1 arrive at the pixel well of the thermal camera, a portion of the photons P1 are either absorbed or deflected by particles or molecules in the surrounding atmosphere A.

In the illustrated example, photons P2 have collided with air molecules or particulates in the atmosphere A, and have had their direction altered from the path of photons P1. Thus these photons do not arrive at the correct (or sometimes any) pixel well of the thermal camera. Thus, the thermal camera will measure, at that particular pixel well, a different (smaller in the illustrated example) number of photons over the integration time period than are actually emitted from the surface element of the device under testing 14 being viewed by that pixel well. Similar errors may be caused at each pixel well of the thermal camera. Photon absorption always reduces the number of counted photons in any pixel well. These are some ways in which the absolute temperature of the device under testing 14, as measured by the thermal camera 12, will be affected by the atmosphere A. These scenarios of molecules or particulates in the atmosphere absorbing or scattering (redirecting) photons away from particular pixel wells in the device under testing 14 are examples of subtractive temperature offset errors that may occur in the thermal camera's 12 measurement of the device under testing 14.

FIG. 3 illustrates several examples of ‘multipath errors’ that may affect the temperature(s) measured by the thermal camera 12. In addition to the subtractive temperature offset errors discussed above, other factors may cause additive temperature offset errors as well as multiplicative offset errors that may occur in the thermal camera's 12 measurement of the device under testing 14. As illustrated in FIG. 3, the environment objects surrounding the device under testing 14, such as the walls, ceiling, and table and including particles or molecules in the ambient air, each have some temperature above absolute zero, and therefore radiate some amount of infrared light in the spectral bands to which thermal camera 12 is sensitive. In the illustrated example, the walls surrounding the device under testing 14 are radiating heat radiation (infrared-light photons). For example, the wall WALL1 radiates some photons including P3, which are deflected by the device under testing 14 towards a given pixel well in the thermal camera 12. From the perspective of thermal camera 12, the photons P3 appear to originate from the surface element in device under testing 14 which the given pixel well is designed to image. Thus, the photons P3 are added to the photon count of photons P1 that are actually being emitted from the device under testing 14 onto the given pixel well of thermal camera 12. Consequently, the measured temperature of the device under testing 14 will be offset by an additive temperature offset error, caused by the photons P3 being deflected towards thermal camera 12. It will be appreciated that any objects outside of the device under testing 14 may potentially cause additive temperature offset errors in the pixels imaged by the measurement by thermal camera 12 of the device under testing 14.

Similarly to the processes discussed above, any photons originating in objects other than the device under testing 14, including air molecules or particulates, will appear to be originating from some imaged surface element of the device under testing 14 from the perspective of the thermal camera 12, provided the last leg of the photon's path, even if the path includes multiple redirections, is directed from that surface element of the device under testing 14 towards the camera optics of the thermal camera 12, and will then cause additive temperature offset errors.

The additive temperature offset errors discussed above occur when additive photons are emitted from a surface or object other than the device under testing 14. On the other hand, a multiplicative temperature error will occur when photons emitted by the device under testing 14, are deflected off other objects multiple times, before being directed back towards the thermal camera 12 from its source surface element on device under testing 14. In the illustrated example, the photons P4 are emitted from the device under testing 14 and are deflected off the wall WALL2 as photons P5. The photons P5 are then deflected from the original (emitting) surface element on device under testing 14, towards the thermal camera 12, and therefore appear to originate from the same surface element of the device-under-testing 14 from whence the primary photons P1 are being emitted. Consequently, as the photons P4 originated from the device under testing 14 itself, these photons will cause a multiplicative temperature error proportional to the actual absolute temperature of the device under testing 14. That is, as the actual temperature of the device under testing 14 increases, the multiplicative temperature error caused by photons such as photons P4 will also proportionally increase. This is also true of subtractive photon-count errors, but subtractive errors reduce photon counts whereas multiplicative errors increase them. It will be appreciated that the depicted and described examples of multipath errors are merely illustrative, and other multipath errors, not specifically discussed above, may also be corrected by the temperature measurement system 10.

In addition to the temperature measurement errors discussed above, an error in the temperature measurement of the device under testing 14 by the thermal camera 12 may be caused by inaccurate prior knowledge of spectral emissivity of the surface materials of the device under testing 14 in the spectral bands to which the thermal camera is sensitive. It will be appreciated that the device under testing 14 will emit only a fraction of the infrared light that an ideal blackbody would emit in any given spectral band to which thermal camera 12 is sensitive, and it will be further appreciated that this fraction is imperfectly known before use of the system and method herein described. This is equivalent to a level of uncertainty in the spectral emissivity of the device under testing in the relevant IR bands. Consequently, the thermal camera 12 only measures a portion of the electromagnetic radiation that would be emitted from the device under testing 14 in the sensitivity bands of camera 12 if the DUT were an ideal blackbody at the same temperature. Had the spectral emissivity of the surface materials of the device under testing 14 been accurately known in these sensitivity bands, the absolute temperature of the device under testing 14 could be calculated (absent the other types of errors described above) by suitably increasing the photon-count measurements of thermal camera 12. This type of emissivity correction is well known to those skilled in the art. However, any inaccuracies in the prior assumed knowledge of the spectral emissivity of the surface material of the device under testing 14 will cause an error in the above calculation.

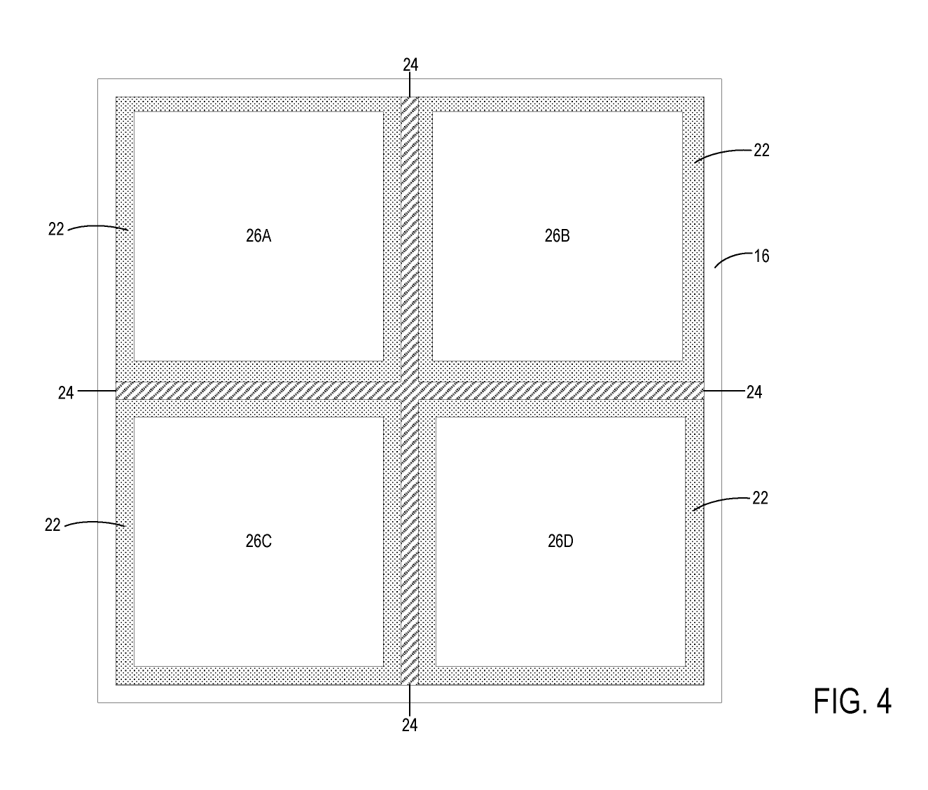

To correct the possible errors caused by the photon-count error categories discussed above, FIG. 4 illustrates one embodiment of an apparatus for use in measuring a temperature of a device under testing 14. The apparatus includes a palette body 16, a plurality of heat distribution plates 22 mounted on the body and positioned adjacent each other, a plurality of insulators 24 positioned intermediate the adjacently positioned heat distribution plates 22, and a plurality of thermal camera calibration reference swatches (26A, 26B, 26C, 26D) including a near-ideal blackbody reference swatch 26A, a diffuse reflective reference swatch 26B, and a first material of the device under testing reference swatch 26C, each reference swatch being mounted on a corresponding one of the heat distribution plates 22 and thermally insulated from other reference swatches by the insulators 24. As one example, the first material of the device under testing reference swatch 26C may comprise a primary surface material of the DUT 14. A primary surface material is a material that constitutes a majority of the external surface of the device under testing 14. It will be appreciated that while the illustrated embodiment depicts four thermal camera calibration reference swatches 26A, 26B. 26C, and 26D, the plurality of thermal camera calibration references swatches may contain any suitable number of reference swatches, such as three, five, or more.

The first material of the device under testing reference swatch 26C includes the same type, or suitable representative type, of external-surface material used in the device under testing 14. If the device under testing 14 is constructed of multiple surface materials and/or textures, a single particular material of the device under testing 14 may be selected for the first material of the device under testing reference swatch 26C. The diffuse reflective reference swatch 26B may include a crumpled reflective material, or any other suitable diffuse reflective material.

In one embodiment, the plurality of heat distribution plates 22 include material having a high thermal conductivity such that each heat distribution plate 22 is configured to evenly distribute heat for the corresponding mounted thermal camera calibration reference swatches 26A-D. For example, the plurality of heat distribution plates may include material such as copper, a carbon material such as graphite or graphene, or any other suitable material having a high thermal conductivity. Thus, in this embodiment, the plurality of heat distribution plates 22 may efficiently distribute heat to and among the mounted reference swatches to minimize any temperature gradients along the mounted reference swatches.

In the embodiment illustrated in FIG. 4, the plurality of thermal camera calibration reference swatches 26A-D and corresponding heat distributions plates 22 are formed in a grid on the palette body 16. However, it will be appreciated that the reference swatches and corresponding heat distribution plates 22 may be formed in any suitable geometrical pattern, such as a single row or single column. In the embodiment illustrated in FIG. 4, the palette body 16 and the plurality of thermal camera calibration references swatches 26A-D are planar.

As discussed above, the plurality of thermal camera calibration reference swatches includes a first material of the device under testing reference swatch 26C. In one embodiment, the plurality of thermal camera calibration reference swatches further includes a plurality of the first material of the device under testing reference swatches. Thus, in the depicted embodiment, both reference swatch 26C and 26D include the first material of the device under testing. However, it will be appreciated that the plurality of thermal camera calibration reference swatches may include more than four reference swatches, and thus may include any suitable number of the first material of the device under testing reference swatches. In another embodiment, the plurality of thermal camera calibration reference swatches 26A-D further includes a second material of the device under testing reference swatch that is different from the first material. As discussed above, the device under testing 14 may include more than one type of surface material. Thus, a second material different from the first material of the device under testing 14 may be selected and included in a reference swatch mounted on the palette body 16, such as reference swatch 26D. However, it will be appreciated that any number of different types of materials from the device under testing 14 may be included among the plurality of thermal camera calibration reference swatches.

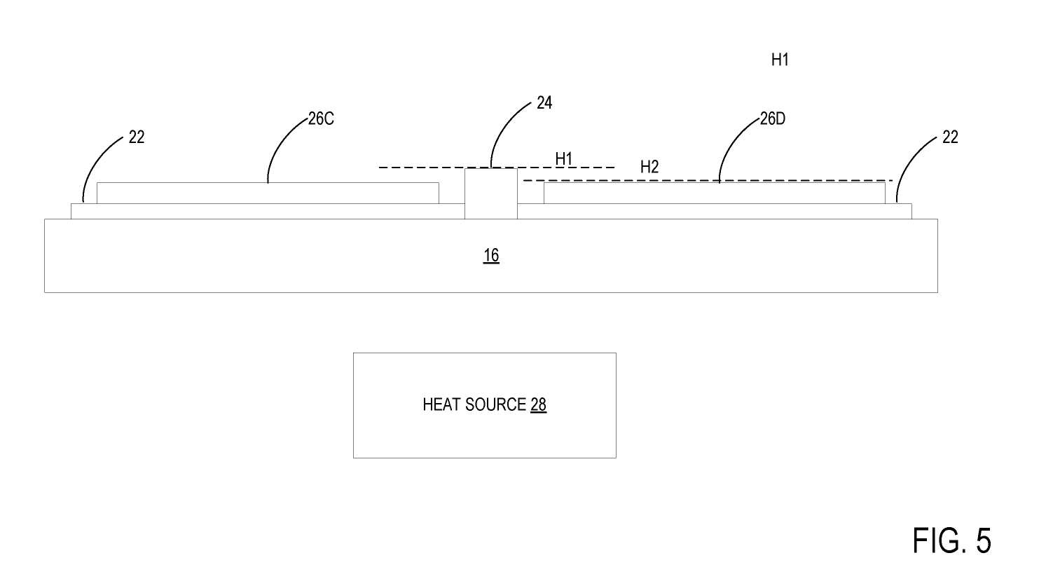

Now turning to FIG. 5, a side view of the embodiment of FIG. 4 is illustrated. In the illustrated embodiment, each insulator 24 is formed as a divider wall laterally intermediate at least two of the plurality of thermal camera calibration reference swatches 26A-D, and may separate those two thermal camera calibration reference swatches from each other. As shown, the insulator 24 is positioned between two reference swatches 26C and 26D. It will be appreciated that the insulators laterally intermediate each other pair of references swatches may also take the form of a divider wall. Further in this embodiment, a height H1 of the divider wall is higher than surfaces of the plurality of thermal camera calibration reference swatches. Specifically, a height H1 of the insulator 24 in the form of a divider wall relative to the palette body 16 is higher than a second height H2 of the surface of the plurality of thermal camera calibration reference swatches 26A-D relative to the palette body 16. Thus, the divider wall in this embodiment, to some degree occludes the lines-of-sight between different reference swatches, thereby preventing heat (infrared) radiation photons emanating from any one reference swatch, from directly affecting the measured temperature of another reference swatch. Further in this embodiment, the divider wall may be configured to optically insulate the plurality of thermal camera calibration reference swatches 26A-D from each other.

The embodiment illustrated in FIG. 5 further comprises a heat source 28 configured to heat each of the plurality of thermal camera calibration reference swatches 26A-D to predetermined temperatures. The heat source 28 may take the form of, for example, a microwave heater, a conductive heater, or any other suitable form of heater. In one embodiment, the plurality of thermal camera calibration reference swatches 26A-D includes a plurality of the first material of the device under testing reference swatches. For example, both reference swatches 26C and 26D may include the first material of the device under testing 14. Further in this embodiment, each of the plurality of the first material of the device under testing reference swatches are heated to different predetermined temperatures. Thus, the heat source 28 may be configured to separately heat each of the plurality of the first material of the device under testing references swatches to different suitable temperatures, such as, for example, 80 degrees Celsius and 100 degrees Celsius.

Turning back to FIG. 1, after receiving the thermal image 20, the processor 19 of the computing device 18 is further configured to measure a temperature of the device under testing 14 and the plurality of thermal camera calibration reference swatches 26A-D based on the thermal image 20. As discussed previously, the per-pixel-well measurements of the thermal camera 12 are affected by different confounding factors, including atmospheric conditions and errors arising from photon absorptions, redirections, and multipaths. Accordingly, the processor 19 is further configured to correct absorption, redirection, scattering, reflection, errors in prior knowledge of spectral emissivity of the device under testing 14, and multipath errors of the measured temperature of the device under testing 14 based on measured temperatures of the plurality of thermal camera calibration reference swatches 26A-D and output a corrected measured temperature of the device under testing 14.

As discussed previously and illustrated in FIGS. 2 and 3, thermal measurement errors due to instances of photon absorption, redirection, scattering, reflection, errors in prior knowledge of spectral emissivity of the device under testing 14, and multipath errors, may (singly or in any combination) cause the temperature of the imaged surface patch(es) of the device under testing 14, as measured by the thermal camera 12, to sustain errors of several kinds, categorized above. For example, the measured temperature may include additive temperature offset errors, subtractive temperature offset errors, and multiplicative temperature errors caused by the factors previously discussed. Errors in prior knowledge of DUT emissivity, effectively constitute a separate source of subtractive and/or multiplicative temperature measurement errors. Thus, in one embodiment, the processor 19 of computing device 18 is further configured to correct the additive temperature offset errors, subtractive temperature offset errors, and multiplicative temperature errors based on measured per-pixel-well temperatures of the plurality of thermal camera calibration reference swatches 26A-D mounted on the palette body 16.

In another embodiment, temperature measurement errors due to inaccurate prior knowledge of spectral emissivity of the surface materials of the device under testing 14 may be corrected based on the measured temperature of the first material of the device under testing reference swatch. It will be appreciated that because the first material of the device under testing reference swatch may comprise a primary surface material of the DUT 14 that constitutes a majority of the external surface of the DUT 14, the first material of the device under testing reference swatch may have the same or substantially similar spectral emissivity characteristics in the relevant bands, as does the surface of the DUT 14. Thus, by comparing the known predetermined temperature of the first material of the device under testing reference swatch to the temperature as measured by thermal camera 12, any temperature measurement errors due to inaccurate knowledge of the spectral emissivity characteristics of the DUT 14 may be corrected accordingly.

In one configuration, the processor 19 of computing device 18 may be configured to execute a correction algorithm that includes arithmetical operations between acquired and digitized values of different pixels of the thermal image 20. The correction algorithms may also include arithmetical operations between acquired and digitized pixels values of thermal image 20, and known predetermined temperature settings of the plurality of thermal camera calibration reference swatches. In one example, the arithmetical operations among different pixel values may include ratios of differences arithmetical operations. In another example, the arithmetical operations include division operations that correct multiplicative photon-count errors such as the multiplicative temperature errors. In yet another example, the arithmetical operations include differencing operations that correct additive and subtractive photon-count errors such as the additive temperature offset errors and the subtractive temperature offset errors.

In one configuration, the device under testing 14 and the palette body 16 are orientated in a same direction O towards the thermal camera 12. As illustrated in FIG. 1, both device under testing 14 and palette body including the thermal camera calibration references swatches are oriented in the same direction O towards the thermal camera.

In addition, in the illustrated configuration of FIG. 1, the palette body 16 and the device under testing 14 are positioned at a first distance D1 from the thermal camera 12, and the palette body 16 and the plurality of thermal camera calibration reference swatches 26A-D have width and length dimensions W1 that are less than 20% of the first distance D1. As one specific example, the first distance may be 1 meter and the length dimension (not labeled) and width dimension W1 of the palette body 16 and mounted plurality of thermal camera calibration reference swatches 26A-D are each less than 20 centimeters. However, it will be appreciated that any suitable distance D1 and length and width dimensions W1 may be chosen as long as the relative ratio is maintained. Further in this embodiment, the palette body and the device under testing are positioned at a second distance D2 from the nearest wall, and the palette body 16 and the plurality of thermal camera calibration reference swatches 26A-D have width and length dimensions W1 that are less than 20% of the second distance D2. Similarly, if the second distance is also, for example, one meter, then the width dimension and length dimension W1 will be set to less than 20 centimeters to meet this design criterion as well. Alternatively, other suitable distances D2 and length dimensions and width dimension W1 may be chosen as long as the relative ratio is maintained. Further, it will be appreciated that the width dimension and length dimension may be equal, for example in the case of a square shaped palette body, or unequal, for example in the case of a rectangular shaped palette body.

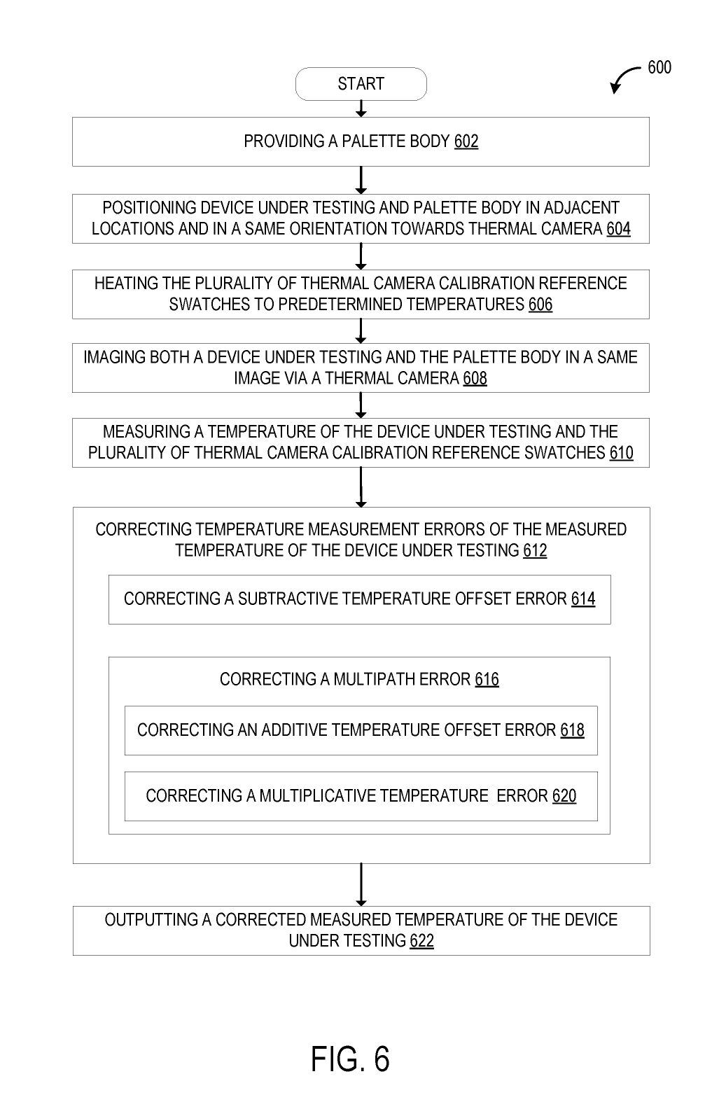

FIG. 6 shows an example method 600 according to an embodiment of the present description. At step 602, the method 600 may include providing a palette body including a plurality of heat distribution plates mounted on the body and positioned adjacent each other, a plurality of insulators positioned intermediate the adjacently positioned heat distribution plates, a plurality of thermal camera calibration reference swatches including a near-ideal blackbody reference swatch, a diffuse reflective reference swatch, and a first material of the device under testing reference swatch, each reference swatch being mounted on a corresponding one of the heat distribution plates and thermally insulated from other reference swatches by the insulators.

Proceeding from step 602 to step 604, the method 600 may include positioning the device under testing and the palette body in adjacent locations and in a same orientation towards the thermal camera.

Advancing from step 604 to step 606, the method 600 may include heating the plurality of thermal camera calibration reference swatches to predetermined temperatures.

Proceeding from step 606 to step 608, the method 600 may include imaging both the device under testing and the palette body in a same image via a thermal camera.

Advancing from step 608 to step 610, the method 600 may include measuring a temperature of the device under testing and the plurality of thermal camera calibration reference swatches based on the thermal camera image.

Proceeding from step 610 to step 612, the method 600 may include correcting temperature measurement errors of the measured temperature of the device under testing based on measured temperatures of the plurality of thermal camera calibration reference swatches. In one embodiment, correcting the temperature measurement errors includes compensation of temperature measurement errors selected from the group consisting of photon absorption, photon redirection, photon scattering, photon reflection, and errors in prior knowledge of spectral emissivity of the device under testing.

In another embodiment, step 612 may contain one or more substeps 614, 616, 618, and 620. At substep 614, the method 600 may include correcting a subtractive temperature offset error based on measured temperatures of the plurality of thermal camera calibration reference swatches. At substep 616, the method 600 may include correcting a multipath error based on measured temperatures of the plurality of thermal camera calibration reference swatches. Substep 616 may include substeps 618 and 620. At substep 618, the method 600 may include correcting an additive temperature offset error based on measured temperatures of the plurality of thermal camera calibration reference swatches. At substep 620, the method 600 may include correcting a multiplicative temperature error based on measured temperatures of the plurality of thermal camera calibration reference swatches.

Advancing from step 612 to step 622, the method 600 may include outputting a corrected measured temperature of the device under testing.

It will be appreciated that the method steps described above may be performed using the algorithmic processes described throughout this disclosure.

In some embodiments, the methods and processes described herein may be tied to a computing system of one or more computing devices. In particular, such methods and processes may be implemented as a computer-application program or service, an application-programming interface (API), a library, and/or other computer-program product.

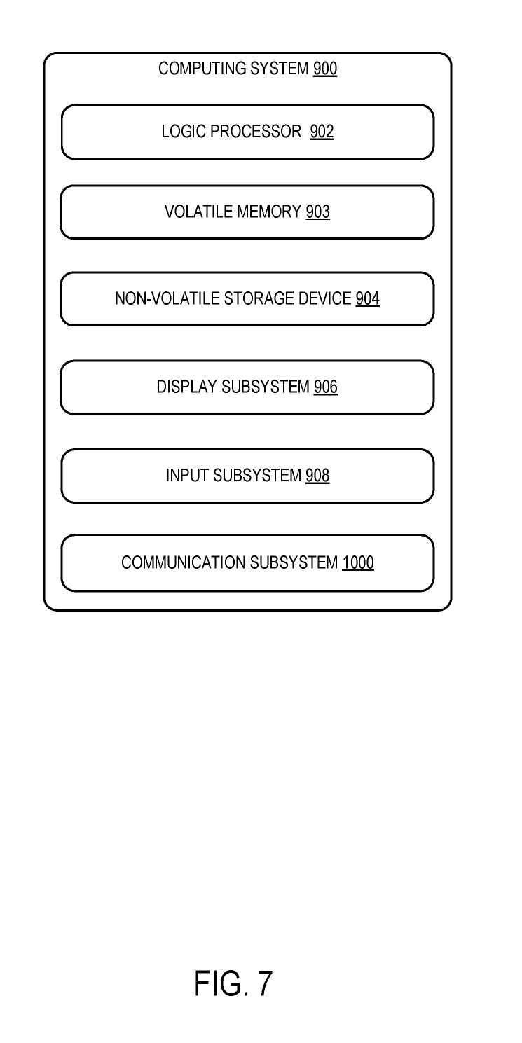

FIG. 7 schematically shows a non-limiting embodiment of a computing system 900 that can enact one or more of the methods and processes described above. Computing system 900 is shown in simplified form. Computing system 900 may embody the computing device 18. Computing system 900 may take the form of one or more personal computers, server computers, tablet computers, network computing devices, mobile computing devices, mobile communication devices (e.g., smart phone), and/or other computing devices.

Computing system 900 includes a logic processor 902 volatile memory 903, and a non-volatile storage device 904. Computing system 900 may optionally include a display subsystem 906, input subsystem 908, communication subsystem 1000, and/or other components not shown in FIG. 7.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, it will be understood that these virtualized aspects are run on different physical logic processors of various different machines.

Non-volatile storage device 904 includes one or more physical devices configured to hold instructions executable by the logic processors to implement the methods and processes described herein. When such methods and processes are implemented, the state of non-volatile storage device 94 may be transformed—e.g., to hold different data.

Non-volatile storage device 904 may include physical devices that are removable and/or built-in. Non-volatile storage device 94 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 904 may include nonvolatile, dynamic, static, read/write, read-only, sequential-access, location-addressable, file-addressable, and/or content-addressable devices. It will be appreciated that non-volatile storage device 904 is configured to hold instructions even when power is cut to the non-volatile storage device 904.

Volatile memory 903 may include physical devices that include random access memory. Volatile memory 903 is typically utilized by logic processor 902 to temporarily store information during processing of software instructions. It will be appreciated that volatile memory 903 typically does not continue to store instructions when power is cut to the volatile memory 903.

Aspects of logic processor 902, volatile memory 903, and non-volatile storage device 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 904, using portions of volatile memory 903. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by non-volatile storage device 904. The visual representation may take the form of a graphical user interface (GUI). As the herein described methods and processes change the data held by the non-volatile storage device, and thus transform the state of the non-volatile storage device, the state of display subsystem 906 may likewise be transformed to visually represent changes in the underlying data. Display subsystem 906 may include one or more display devices utilizing virtually any type of technology. Such display devices may be combined with logic processor 902, volatile memory 903, and/or non-volatile storage device 904 in a shared enclosure, or such display devices may be peripheral display devices.

When included, input subsystem 908 may comprise or interface with one or more user-input devices such as a keyboard, mouse, touch screen, microphone, camera, or game controller.

When included, communication subsystem 1000 may be configured to communicatively couple various computing devices described herein with each other, and with other devices. Communication subsystem 1000 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

The following paragraphs provide additional support for the claims of the subject application. One aspect provides an apparatus for use in measuring a temperature of a device under testing, the apparatus comprising a palette body, a plurality of heat distribution plates mounted on the palette body and positioned adjacent each other, a plurality of insulators positioned intermediate the adjacently positioned heat distribution plates, and a plurality of thermal camera calibration reference swatches, including a near-ideal blackbody reference swatch, a diffuse reflective reference swatch, and a first material of the device under testing reference swatch, each reference swatch being mounted on a corresponding one of the heat distribution plates and thermally insulated from other reference swatches by the insulators. In this aspect, additionally or alternatively, the plurality of heat distribution plates may include material having a high thermal conductivity such that each heat distribution plate is configured to evenly distribute heat for the corresponding mounted thermal camera calibration reference swatch. In this aspect, additionally or alternatively, the plurality of thermal camera calibration reference swatches and corresponding heat distributions plates may be formed in a grid on the palette body. In this aspect, additionally or alternatively, the palette body and the plurality of thermal camera calibration references swatches may be planar. In this aspect, additionally or alternatively, the plurality of thermal camera calibration reference swatches may further include a plurality of the first material of the device under testing reference swatches. In this aspect, additionally or alternatively, the apparatus may further comprise a heat source configured to heat each of the plurality of thermal camera calibration reference swatches to predetermined temperatures, wherein each of the plurality of the first material of the device under testing reference swatches are heated to different predetermined temperatures. In this aspect, additionally or alternatively, the plurality of thermal camera calibration reference swatches may further include a second material of the device under testing reference swatch that is different from the first material. In this aspect, additionally or alternatively, each insulator may be formed as a divider wall laterally intermediate at least two of the plurality of thermal camera calibration reference swatches. In this aspect, additionally or alternatively, a height of each divider wall may be higher than surfaces of the plurality of thermal camera calibration reference swatches.

Another aspect provides a method comprising providing a palette body including a plurality of heat distribution plates mounted on the body and positioned adjacent each other, a plurality of insulators positioned intermediate the adjacently positioned heat distribution plates, a plurality of thermal camera calibration reference swatches including a near-ideal blackbody reference swatch, a diffuse reflective reference swatch, and a first material of the device under testing reference swatch, each reference swatch being mounted on a corresponding one of the heat distribution plates and thermally insulated from other reference swatches by the insulators, heating the plurality of thermal camera calibration reference swatches to predetermined temperatures, imaging both a device under testing and the palette body in a same image via a thermal camera, measuring a temperature of the device under testing and the plurality of thermal camera calibration reference swatches based on the thermal camera image, correcting temperature measurement errors of the measured temperature of the device under testing based on measured temperatures of the plurality of thermal camera calibration reference swatches, and outputting a corrected measured temperature of the device under testing. In this aspect, additionally or alternatively, correcting temperature measurement errors may include compensation of temperature measurement errors selected from the group consisting of photon absorption, photon redirection, photon scattering, photon reflecting, and errors in prior knowledge of spectral emissivity of the device under testing. In this aspect, additionally or alternatively, correcting temperature measurement errors may include correcting a subtractive temperature offset error based on measured temperatures of the plurality of thermal camera calibration reference swatches. In this aspect, additionally or alternatively, correcting temperature measurement errors may include correcting a multipath error based on measured temperatures of the plurality of thermal camera calibration reference swatches. In this aspect, additionally or alternatively, correcting multipath errors may include correcting an additive temperature offset error based on measured temperatures of the plurality of thermal camera calibration reference swatches. In this aspect, additionally or alternatively, correcting multipath errors may include correcting a multiplicative temperature error based on measured temperatures of the plurality of thermal camera calibration reference swatches. In this aspect, the method may additionally or alternatively include, positioning the device under testing and the palette body in adjacent locations and in a same orientation towards the thermal camera.

Another aspect provides a temperature measurement system comprising a thermal camera, a device under testing, and a palette body including a plurality of heat distribution plates mounted on the body and positioned adjacent each other, a plurality of insulators positioned intermediate the adjacently positioned heat distribution plates, a plurality of thermal camera calibration reference swatches including a near-ideal blackbody reference swatch, a diffuse reflective reference swatch, and a first material of the device under testing reference swatch, each reference swatch being mounted on a corresponding one of the heat distribution plates and thermally insulated from other reference swatches by the insulators, a computing device including a processor configured to receive a thermal image including both the device under testing and the palette body from the thermal camera, measure a temperature of the device under testing and the plurality of thermal camera calibration reference swatches based on the thermal image, correct temperature measurement errors of the measured temperature of the device under testing based on measured temperatures of the plurality of thermal camera calibration reference swatches, and output a corrected measured temperature of the device under testing. In this aspect, additionally or alternatively, the device under testing and the palette body may be orientated in a same direction towards the thermal camera. In this aspect, additionally or alternatively, the palette body and the device under testing may be positioned at a first distance from the thermal camera, and the palette body and the plurality of thermal camera calibration reference swatches may have width and length dimensions that are less than 20% of the first distance. In this aspect, additionally or alternatively, the palette body and the device under testing may be positioned at a second distance from nearby walls, and the palette body and the plurality of thermal camera calibration reference swatches may have width and length dimensions that are less than 20% of the second distance.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An apparatus for use in measuring a temperature of a device under testing, the apparatus comprising:
a palette body;
a plurality of heat distribution plates mounted on the palette body and positioned adjacent each other;
a plurality of insulators positioned intermediate the adjacently positioned heat distribution plates; and
a plurality of thermal camera calibration reference swatches, including a near-ideal blackbody reference swatch, a diffuse reflective reference swatch, and a first material of the device under testing reference swatch, each reference swatch being mounted on a corresponding one of the heat distribution plates and thermally insulated from other reference swatches by the insulators.

2. The apparatus of claim 1, wherein the plurality of heat distribution plates include material having a high thermal conductivity such that each heat distribution plate is configured to evenly distribute heat for the corresponding mounted thermal camera calibration reference swatch.

3. The apparatus of claim 1, wherein the plurality of thermal camera calibration reference swatches and corresponding heat distributions plates are formed in a grid on the palette body.

4. The apparatus of claim 1, wherein the palette body and the plurality of thermal camera calibration references swatches are planar.

5. The apparatus of claim 1, wherein the plurality of thermal camera calibration reference swatches further includes a plurality of the first material of the device under testing reference swatches.

6. The apparatus of claim 5, further comprising:
a heat source configured to heat each of the plurality of thermal camera calibration reference swatches to predetermined temperatures;
wherein each of the plurality of the first material of the device under testing reference swatches are heated to different predetermined temperatures.

7. The apparatus of claim 1, wherein the plurality of thermal camera calibration reference swatches further includes a second material of the device under testing reference swatch that is different from the first material.

8. The apparatus of claim 1, wherein each insulator is formed as a divider wall laterally intermediate at least two of the plurality of thermal camera calibration reference swatches.

9. The apparatus of claim 8, wherein a height of each divider wall is higher than surfaces of the plurality of thermal camera calibration reference swatches.

10. A method comprising:
providing a palette body including a plurality of heat distribution plates mounted on the body and positioned adjacent each other, a plurality of insulators positioned intermediate the adjacently positioned heat distribution plates, a plurality of thermal camera calibration reference swatches including a near-ideal blackbody reference swatch, a diffuse reflective reference swatch, and a first material of the device under testing reference swatch, each reference swatch being mounted on a corresponding one of the heat distribution plates and thermally insulated from other reference swatches by the insulators;
heating the plurality of thermal camera calibration reference swatches to predetermined temperatures;
imaging both a device under testing and the palette body in a same image via a thermal camera;
measuring a temperature of the device under testing and the plurality of thermal camera calibration reference swatches based on the thermal camera image;
correcting temperature measurement errors of the measured temperature of the device under testing based on measured temperatures of the plurality of thermal camera calibration reference swatches; and
outputting a corrected measured temperature of the device under testing.

11. The method of claim 10, wherein correcting temperature measurement errors includes compensation of temperature measurement errors selected from the group consisting of photon absorption, photon redirection, photon scattering, photon reflection, and errors in prior knowledge of spectral emissivity of the device under testing.

12. The method of claim 10, wherein correcting temperature measurement errors includes correcting a subtractive temperature offset error based on measured temperatures of the plurality of thermal camera calibration reference swatches.

13. The method of claim 10, wherein correcting temperature measurement errors includes correcting multipath errors based on measured temperatures of the plurality of thermal camera calibration reference swatches.

14. The method of claim 13, wherein correcting multipath errors includes correcting an additive temperature offset error based on measured temperatures of the plurality of thermal camera calibration reference swatches.

15. The method of claim 13, wherein correcting multipath errors includes correcting a multiplicative temperature error based on measured temperatures of the plurality of thermal camera calibration reference swatches.

16. The method of claim 10, further comprising positioning the device under testing and the palette body in adjacent locations and in a same orientation towards the thermal camera.

17. A temperature measurement system comprising:
a thermal camera;
a device under testing; and
a palette body including:
a plurality of heat distribution plates mounted on the body and positioned adjacent each other;
a plurality of insulators positioned intermediate the adjacently positioned heat distribution plates;
a plurality of thermal camera calibration reference swatches including a near-ideal blackbody reference swatch, a diffuse reflective reference swatch, and a first material of the device under testing reference swatch, each reference swatch being mounted on a corresponding one of the heat distribution plates and thermally insulated from other reference swatches by the insulators;
a computing device including a processor configured to:
receive a thermal image including both the device under testing and the palette body from the thermal camera;
measure a temperature of the device under testing and the plurality of thermal camera calibration reference swatches based on the thermal image;
correct temperature measurement errors of the measured temperature of the device under testing based on measured temperatures of the plurality of thermal camera calibration reference swatches; and
output a corrected measured temperature of the device under testing.

18. The temperature measurement system of claim 17, wherein the device under testing and the palette body are orientated in a same direction towards the thermal camera.

19. The temperature measurement system of claim 17, wherein the palette body and the device under testing are positioned at a first distance from the thermal camera; and
wherein the palette body and the plurality of thermal camera calibration reference swatches have width and length dimensions that are less than 20% of the first distance.

20. The temperature measurement system of claim 19, wherein the palette body and the device under testing are positioned at a second distance from nearby walls; and
wherein the palette body and the plurality of thermal camera calibration reference swatches have width and length dimensions that are less than 20% of the second distance.
